(19) United States
(12) Patent Application Publication
(10) Pub. No.: US 2018/0248929 A1
(43) Pub. Date: Aug. 30, 2018

(54) METHOD TO GENERATE AND TRANSMIT ROLE-SPECIFIC AUDIO SNIPPETS

(71) Applicant: MOTOROLA SOLUTIONS, INC., Chicago, IL (US)

(72) Inventors: Huimin HAN, Chengdu, Sichuan (CN); Haiqing HU, Chengdu, Sichuan (CN); David E. KLEIN, Parkland, FL (US); Jianfeng WANG, Chengdu, Sichuan (CN); Liang XU, Chengdu, Sichuan (CN); Licheng ZHAO, Chengdu, Sichuan (CN)

(21) Appl. No.: 15/753,430

(22) PCT Filed: Sep. 2, 2015
(86) PCT No.: PCT/CN2015/088856

§ 371 Date: Feb. 19, 2018

(51) Int. Cl. H04L 29/06; H04L 29/08

(52) U.S. Cl. CPC H04L 65/601; H04L 67/306; H04L 65/4061

(57) ABSTRACT

A method for controlling a communications system. In one exemplary embodiment, at least one user attribute for a user associated with a first communication device is determined. A plurality of received audio stream snippets are analyzed based on the at least one user attribute. At least one audio stream snippet characteristic is determined for each received audio stream snippet of the plurality of received audio stream snippets based on the at least one user attribute of the user associated with the first communication device. If an audio stream snippet of the plurality of received audio stream snippets is relevant to the user associated with the first communication device based on the determined at least one audio stream snippet characteristic and the at least one user attribute, then data corresponding to at least one audio stream snippet of the plurality of received audio stream snippets is transmitted to the first communication device when the at least one audio stream snippet is determined to be relevant to the user associated with the first communication device.

### BACKGROUND OF THE INVENTION

Same emergency incidents require responses from multiple public safety agencies or departments. For example, emergency management of a structure fire requires a response and services from a fire department, but will often require a response and services from police and emergency medical departments. Personnel from each of these departments have different roles at the scene of the fire. For example, police officers work to secure the scene, the firefighters work to suppress the fire, and the emergency medical personnel treat injuries. In some instances, similar personnel from multiple jurisdictions respond to an emergency incident. The responding public safety personnel often use a land-mobile radio network (or other electronic voice communications modalities) to coordinate the response to the emergency incident. The timely delivery of pertinent information to public safety personnel over the land-mobile radio network maximizes the effectiveness of the overall response. However, in some cases, certain public safety personnel are called to the emergency scene after the response has begun, and they have not received the communications between personnel already on scene other cases, the noise and hectic pace at m emergency scene may make it difficult for some public safety personnel to hear pertinent communications. Furthermore, the sheer volume of information being delivered may make it difficult for some public safety personnel to identify and comprehend all information pertinent to their role at the emergency scene.

Accordingly, there is a need for a method to generate and transmit role-specific audio snippets.

### BRIEF DESCRIPTION OF THE SEVERAL VIEWS OF THE DRAWINGS

The accompanying figures, where like inference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communications system in accordance with some embodiments.

FIG. 2 is a flowchart of a method to generate and transmit role-specific audio snipped in accordance with some embodiments.

Skilled artisans will appreciate that elements in the figures are illustrated for simplicity and clarity and have not necessarily been drawn to scale. For example, the dimensions of some of the elements in the figures may be exaggerated relative to other demerits to help to improve understanding of embodiments of the present invention.

The apparatus and method components have been represented where appropriate by conventional symbols in the drawings, showing only those specific details that are pertinent to understanding the embodiments of the present invention so as not to obscure the disclosure wish details that will be readily apparent so those of ordinary skill in the art having the benefit of the description herein.

### DETAILED DESCRIPTION OF THE INVENTION

One embodiment provides a method for controlling a communications system. In one exemplary embodiment, the method includes determining at least one user attribute for a user associated with a first communication device. The method further includes determining at least one audio stream snippet characteristic for each received audio stream snippet of the plurality of received audio stream snippets. The method further includes determining whether an audio stream snippet of the plurality of received audio stream snippets is relevant to the user associated with the first communication device based on the determined at least one audio stream snippet characteristic and the at least one user attribute. The method further includes transmitting data corresponding to at least one audio stream snippet of the plurality of received audio stream snippets to the first communication device when the at least one audio stream snippet is determined to be relevant to the user associated with the first communication device.

Some embodiments include a communications system. The communications system includes a communications system base station and a communications system controller. The communications system controller includes an electronic processor. The electronic processor is configured to determine at least one user attribute for a user associated with a first communication device. The electronic processor is further configured to receive a plurality of audio stream snippets from the communications system base station. The electronic processor is further configured to determine at least one audio stream snippet characteristic for each received audio stream snippet of the plurality of received audio stream snippets. The electronic processor is further configured to determine whether an audio stream snippet of the plurality of received audio stream snippets is relevant to the user associated with the first communication device based on tie determined at least one audio stream snippet characteristic and the at least one user attribute. The electronic processor is further configured to transmit via the communications system base station data corresponding to at least one audio stream snippet of the plurality of received audio stream snippets to the first communication device when the at least one audio stream snippet is determined to be relevant to the user associated with the first communication device.

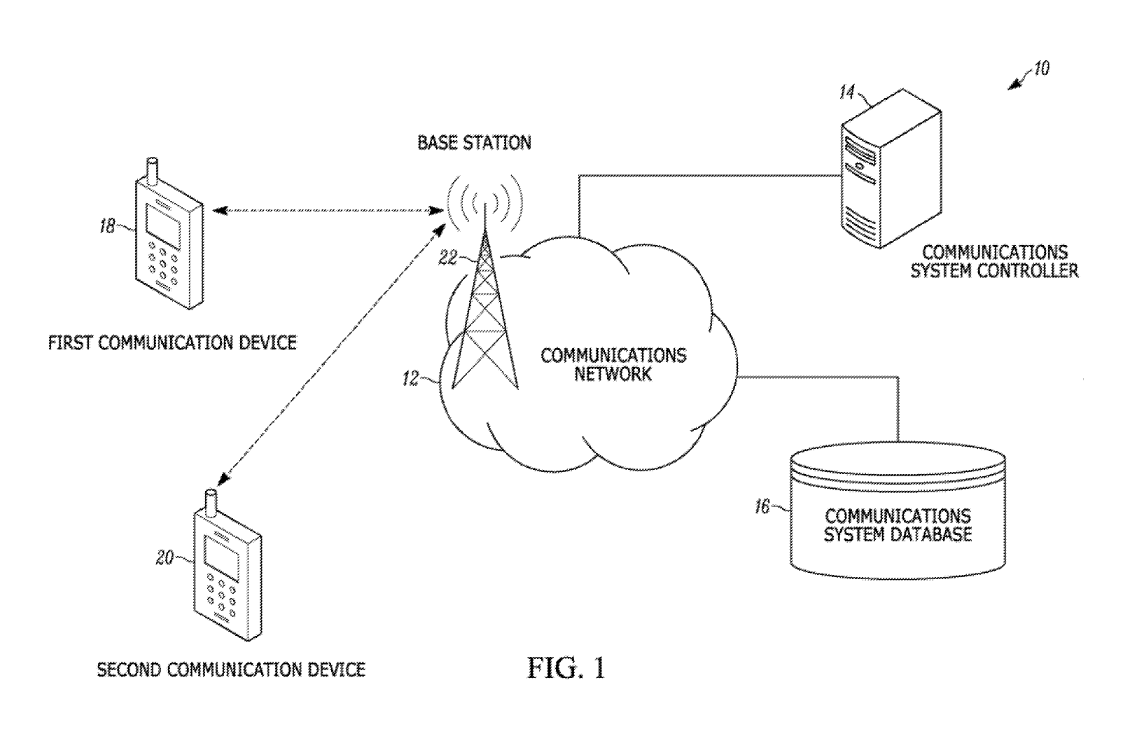

FIG. 1 illustrates a communications system 10. The communications system 10 includes a communications network 12, a communications system controller 14, and a communications system database 16. The communications system 10 also includes a first communication device 18, a second communication device 20, and a base station 22. For ease of description, the communications system 10 illustrated in FIG. 1 includes one communications network 12, one communications system controller 14, one communication system database 16, one first communication device 18, one second communication device 20, and one base station 22. Other embodiments may include more or less than each of these components as well as other alternative components.

The communications network 12 interconnects the communications system controller 14, the communication a system database 16, the first communication device 18, and the second communication device 20. The communications network 12 passes voice traffic, data traffic, or both, to, from, and between the communications system controller 14, the communications system database 16, the first communication device 18, and the second communication device 20 using suitable network protocols, connections, and equipment. The voice communications include audio stream snippets, which are individual segments of audio transmitted by users of the communications network 12 (for example, a transmission by a firefighter that the fire in a particular part of a building has been extinguished).

The communications network 12 may include land-mobile radio access networks, cellular networks (for example, long-term evolution (LTE)), landline telephone lines, local and wide area data networks, or other communications networks and links. The communications network 12 may include or have one or more connections to the public switched telephone network (PSTN) and the Internet. Portions of the communications network 12 may switch or route network traffic, including voice telephone calls (for example, cellular and landline calls), digital and analog radio communications, voice over internet protocol (VoIP), short message service (SMS) messages and multimedia message service (MMS) messages (“text messages”), transmission control protocol/internet protocol (TCP/IP) data traffic, and the like.

In some embodiments, the communications system controller 14 includes, among other things, an electronic processor (for example, a microprocessor or another suitable programmable device), a memory (that is, a computer-readable storage medium), and an input/output interface (not shown). The electronic processor, the memory, and the input/output interface, as well as the other various modules are connected by one or more control or data buses. The use of control and data buses for the interconnection between and communication among the various modules and components would be known to a person skilled in the art in view of the invention described herein.

The memory may include a program storage area and a data storage area. The processor is connected to the memory and executes computer readable code (“software”) stored in a random access memory (RAM) of the memory (for example, daring execution), a read only memory (ROM) of the memory (for example, on a generally permanent basis), or another non-transitory computer readable medium. Software can be stored in the memory. The software may include firmware, one or more applications, program data, filters, rules, one or more program modules, and/or other executable instructions. The processor is configured to retrieve from the memory and execute, among other things, instructions related to the processes and methods described herein.

In some embodiments, the communications system controller 14 is capable of performing audio speech-to-text analysis on audio streams and audio stream snippets transmitted through the communications system 10.

In some embodiments, the communications system controller 14 is configured to perform machine learning functions. Midline learning generally refers to the ability of a computer program to learn without being explicitly programmed. In some embodiments, a computer program (for example, a learning engine) is configured to construct an algorithm based on inputs. Supervised learning involves presenting a computer program with example inputs and their desired (for example, actual) outputs. The computer program is configured to learn a general rule (for example, an algorithm) that maps the inputs to the outputs from the training data it receives. Machine learning can be performed using various types of methods and mechanisms. Example machine learning engines include decision tree learning, association rule learning, artificial neural networks, inductive logic programming, support vector machines, clustering, Bayesian networks, reinforcement learning, representation learning, similarity and metric learning, sparse dictionary learning, and genetic algorithms. Using all of these approaches, a computer program can ingest, parse, and understand data and progressively refine algorithms for data analytics.

The communications system database 16 electronically stores information regarding the communications network 12, including, for example, information relating to the operation of the communications network 12 according to the methods described herein. The communications system controller 14 is configured to read and write such information to and from the communications system database 16. In the illustrated embodiment, the communications system database 16 is a database housed on a suitable database server and accessible by the communications system controller 14 and other systems (not shown) over the communications network 12. In alternative embodiments, the communications system database 16 may be located on the communications system controller 14, or on a system external to the communications network 12 and accessible over one or more intervening networks.

The first communication device 18 and the second communication device 20 include hardware and software that provide the capability for the devices to communicate wirelessly over the communications network 12. In many of the embodiments described herein, the first communication device 18 and the second communication device 20 are land-mobile radio (LMR) devices (for example, portable or mobile radios). In alternative embodiments, either or both the first communication device and the second communication device 20 may include hardware and software that allow the devices to communicate wirelessly using long-term evolution (LTE) protocols.

The base station 22 is coupled to the communications network 12. The base station 22 enables wireless communication between the communications network 12, the first communication device 18, and the second communication device 20 using suitable wireless communication equipment and protocols. Base stations are known, and will not be described in detail herein.

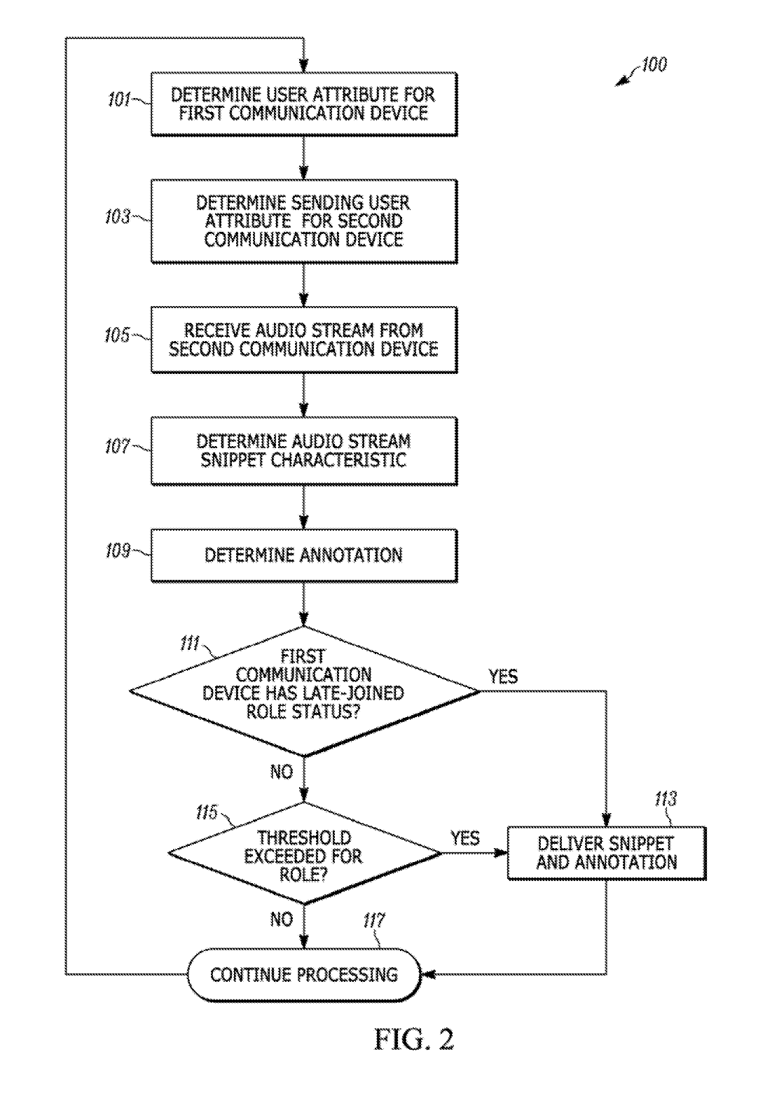

FIG. 2 illustrates a method 100 for generating and transmitting role-specific audio snippets. As an example, method 100 is described in terms of public safety personnel responding to an emergency incident, for example, a structure fire. In the exemplary embodiment the first communication device 18 may need to receive an audio stream snippet generated by the second communication device 20. As noted above, other embodiments include more than two communication devices. Additionally, embodiments of the invention process more than one audio stream snippet. For example, the communications system controller 14 executes method 100 repetitively to continuously receive and process the audio stream snippets being transmitted in the communications network 12. Some embodiments of the invention are capable of processing multiple audio stream snippets simultaneously.

At block 101, the communications system controller 14 determines at least one user tribute for the user of the first communication device 18. The user attributes provide information about, for example, what the user of the first device is doing or may be able to do at the emergency scene. One example of a user attribute is the user's field role at the emergency scene. The field role may be based on the user's agency (for example, police, fire, military), and the users assigned role within the agency or at the emergency scene (for example, perimeter security, fire suppression, support services, medical, supervisory, etc.). Another example is the user's current task or recently assigned tasks (for example, providing medical care to a particular person or area), and information about recently assigned tasks (both complete and incomplete). Another example is the user's current status including the user's deployment status (for example, on call or enroute), the user's shift status (for example, just on duty, mid-shift, end of shift, off shift), and the user's group status (for example, part of a larger group or an individual deployment).

Another example of a user attribute is the user's communication status including the duration of the user's calls, the frequency of the user's calls, and the roles or users those calls were to or from. Another example is the user's location (for example, where the user is located at the emergency scene), and how they are able move about the scene (for example, on foot or in a vehicle). Another example of a user attribute is the user's relevant skills or training (for example, hazardous materials training, advanced rescue training, or particular medical training). Another example is any specialized equipment or vehicles associated with the user (that is, an equipment association) (for example, cutting equipment, special weapons, an ambulance, a squad car, etc.).

Another example of a user attribute is a context value associated with the user. In one embodiment a context value us an indication of whether the location of the first communication device 18 within the emergency scene would allow a user of the first communication device 18 to understand audio stream snippets. For example, the first communication device 18 may detect (for example, using microphone sensors) that it is in a noisy environment that could prevent a user from clearly hearing the audio stream snippet. The communication system controller 14 is configured to hold delivery of the audio stream snippet until the first communication device 18 moves to a less noisy environment or until the noise drop below an acceptable level. In another embodiment, the context value represents the stress level of a user of the first communication device 18. Stress levels may be detected using biometric sensors to sense for example, heart rate and blood pressure. In another example, the communications system controller 14 is configured to analyze the received audio from the first communication device 18 for indications of stress in the user's voice. If the context value indicates that a user is under too much stress to receive an audio stream snippet the communication system controller 14 is configured to hold delivery of the audio stream snippet until the user's stress levels fall below an acceptable level.

After determining user attributes for the first communication device 18, the communications system controller 14 determines at least one sending user attribute for a sending user of the second communication device 20 (at block 103). The sending user attributes of the second communication device are similar to the user attributes for the first communication device 18. The sending user attributes provide information regarding the audio stream snippets received by the communications system controller 14 from the second communication device 20.

At block 105, the communications system controller 14 receives an audio stream snippet from the second communication device 20 via the base station 22 and the communications network 12. The communications system controller 14 saves the audio stream snippet in an electronic format to a memory, or to the communications system database 16, from which the communications system controller 14 can access the audio stream snippet for analysis and retransmission (as described in more detail below).

At block 107, the communications system controller 14 analyzes the audio stream snippet to determine at least one audio stream snippet characteristic for the audio stream snippet. The communications system controller 14 uses the audio stream snippet characteristics to prioritize the audio stream snippet with respect to first communication device 18 based on the user attributes determined at block 101. In some embodiments, the communications system controller 14 performs speech-to-text analysis on the audio stream snippets and uses machine learning functions to determine the audio stream snippet characteristics. In some embodiments, each audio stream characteristic is assigned a priority value, and the value is multiplied by a weight representing an importance for the particular audio stream characteristic. In some embodiments, the communications system controller 14 may utilize machine learning engines and predictive models to determine the audio stream snippet characteristics.

In one example, the communications system controller 14 determines an audio stream relevance value for the snippet. The audio stream relevance is determined by using speech-to-text analysis and keyword analytics. Keywords may include, for example, words indicating the location of an injured person, a bomb, or a fire. Other key words may indicate the status of a fire, or a structure that is on fire. Which keywords are determined relevant depends on the emergency situation.

In another example, the communications system controller 14 determines an audio stream severity value for the audio stream snippet. The communications system controller 14 uses speech-to-text analysis to determine keywords, and analyzes the audio for the keywords for characteristics including, for example, stress in the user's voice, the speed of the words, background noise, and intelligibility. The communications system controller 14 uses these characteristics, combined with the call type (for example one-to-many, one-to-one, emergency call, hot mic, or ambient listening) to determine how important the audio stream snippet is in relation to the role of the sending user.

In another example, the communications system controller 14 determines a push-to-talk (PTT) activity (or push-to-talk audio traffic volume) value for the snippet. Push-to-talk activity is a measure of the activation of the push-to-talk button for the second communication device and/or other communication devices during the generation of the audio stream snippet. The communications system controller 14 analyzes the audio stream snippet to determine, for example, how many push-to-talk actions are tied to the audio stream snippet or particular keywords in the audio stream snippet. Other examples of push-to-talk activity include how quickly responses were occurring within the audio stream snippet, how many unique devices make up the audio stream snippet, how many push-to-talk requests were denied, and how many people were in the talk group during the audio stream snippet. In some embodiments, the communications system controller 14 may infer that audio stream snippets with higher levels of push-to-talk activity have a higher priority value.

In another example, the communications system controller 14 determines m audio stream source reference value for the audio stream snippet. The communications system controller 14 determines the audio stream source reference value based on, for example, the age of the audio stream snippet and the proximity of the second communication device 20 to the first communication device 18.

In each of the above examples, the priority value for the audio stream snippet characteristic is determined in relation to the user attributes for the first communication device. For example, the communication system controller 14 will filter and analyze keywords based on the field role. For example, a police officer on perimeter security duty may not need to hear audio stream snippets relating to fire suppression in the center of the scene.

In addition to determining priority values for the audio stream snippet characteristics, the communications system controller 14 determines a weight for each priority value based on the sending user attributes, the user attributes, and information relating to the emergency scene. For example, push-to-talk activity may be weighted less heavily for a newly arriving user, because the user was not able to hear any traffic at all prior to arriving. In another example, audio relevance may he weighted heavily for an emergency response involving many agencies and personnel.

When the priority values and weights have been determined, the communications system controller 14 multiples the priority values by the weight values for each audio stream snippet characteristic, and adds the results to determine a total priority value for the audio stream snippet based on the user attributes of the first communication device 18. This total priority value determines whether the audio stream snippet is relevant to the user of the first communication device 18.

At block 109, in some embodiment the communications system controller 14 determines at least one annotation for the audio stream snippet. An annotation is supplementary electronic data (for example, a text string, a picture, or an audio or video file) that provides the recipient of the audio stream snippet with information regarding the audio stream snippet. In such embodiments, the first communication device 18 is capable of receiving and displaying (or playing) the electronic file. The audio stream snippet annotations may be a speech-to-text translation of the audio stream snippet (for example, in a noisy environment), an audio stream snippet source (for example, an indication of the sender of the audio stream snippet), a location for the source, a timestamp for the audio stream snippet, an audio stream snippet emergency level, snippet logical meta data, or a combination of the foregoing. In some embodiments, the annotation may snippet rich data (for example, an audio file of the audio stream snippet, which can he stored in the first communication device 18 and played back at a later time). In some embodiments, a snippet rich data annotation may be a video clip.

At block 111, when the first communication device 18 has a late-joined role status (for example, the first communication device 18 associates with a particular user's field role that is new to the emergency scene), the relevant audio stream snippet and annotation are delivered to the first communication device 18 at block 113. For example, a firefighter (and user of the first communication device 18) arrives on the scene of a fire. The firefighter was dispatched after a police officer, using the second communication device 20, called in the details of the fire after discovering it. When the first communication device 18 checks into the scene, the communications system controller sends relevant audio stream snippets regarding the fire to the first communication device 18 (for example, the location of the flames and the police officer's observation that a propane tank is located at the rear of the property).

At block 111, when the first communication device 18 is not new to the emergency scene, the communications system controller 14 determines whether a priority threshold for the user's field role is exceeded by the audio stream snippet's total priority value. When the priority threshold is exceeded, the audio stream snippet and annotation are delivered, as illustrated at block 113. For example, an audio stream snippet relating to the structural integrity of a building that is on fire would likely exceed the priority threshold for a user of the first communication device 18 with a field role relating to firefighting or a location inside the structure. In such an example, the communications system controller 14 would transmit the audio stream snippet and annotation to the first communication device 18.

In some embodiments, transmitting the audio stream snippet and annotation includes transmitting a single relevant audio stream snippet and annotation. In other embodiments, a summary of relevant snippets and corresponding annotations are delivered as a group to the first communication device 18.

After delivery of an audio stream snippet and annotation, or a determination that the audio stream snippet and annotation will not be delivered, the communications system controller 14 continues processing at block 117. As noted above, additional audio stream snippets are received and analyzed for relevance to the user of the first communication device 18 or other users of other communication devices in the communications network 12.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entitles or actions. The terms “containing,” “comprising,” “has”, “having,” “includes”, “including,” “contains”, “containing” or any other variation thereof are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will he readily capable of generating such software instructions and programs and ICs with minimal experimentation.

The Abstract of the Disclosure is provided to allow the reader to quickly as certain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for controlling a communications system, the method comprising:
determining at least one user attribute for a user associated with a first communication device;
determining at least one audio stream snippet characteristic for each received audio stream snippet of the plurality of received audio stream snippets;
determining whether an audio stream snippet of the plurality of received audio stream snippets is relevant to the user associated with the first communication device based on the determined at least one audio stream snippet characteristic and the at least one user attribute; and
transmitting data corresponding to at least one audio stream snippet of the plurality of received audio stream snippets to the first communication device when the at least one audio stream snippet is determined to be relevant to the user associated with the first communication device.

2. The method of claim 1, wherein determining the at least one user attribute includes determining at least one attribute from a group of attributes consisting of a field role, a current task, a current status, a communication status, a location, a skill, an equipment association, and a context value; and
determining the at least one audio stream snippet characteristic includes determining the at least one audio stream snippet characteristic based on the at least one user attribute of the user associated with the first communication device.

3. The method of claim 1, wherein determining the at least one audio stream snippet characteristic includes determining at least one characteristic from a group of characteristics consisting of an audio stream relevance, an audio stream severity, a push-to-talk audio traffic volume, and an audio stream source reference.

4. The method of claim 1, further comprising determining at least one annotation based on the at least one audio stream snippet wherein transmitting the data corresponding to the at least one audio stream snippet includes transmitting the at least one annotation.

5. The method of claim 4, wherein determining the at least one annotation includes determining an audio stream snippet emergency level, an audio stream snippet source, snippet rich data, and snippet logical meta data.

6. The method of claim 1, further comprising determining at least one sending user attribute for a sending user associated with a second communication device, wherein determining whether an audio stream snippet of the plurality of received audio stream snippets is relevant to the user associated with the first communication device is based on the at least one sending user attribute.

7. The method of claim 6, wherein determining the at least one sending user attribute includes determining at least one attribute from a group of attributes consisting of a field sole, a current task, a current status, a communication status, a location, a skill, art equipment association, and a contest value.

8. The method of claim 1, wherein determining whether an audio stream snippet of the plurality of received audio stream snippets is relevant to the user associated with the first communication device includes determining a late-joined role status for the user associated with the first communication device.

9. The method of claim 1, wherein determining whether an audio stream snippet of the plurality of received audio stream snippets is relevant to the user associated with the first communication device includes
determining a priority value for each received audio stream snippet of the plurality of received audio stream snippets based on the at least one audio stream snippet characteristic; and
determining a priority threshold for the user associated with the first communication device.

10. A communications system, the system comprising:
a communications system base station; and
a communications system controller including
an electronic processor configured to
determine at least one user attribute for a user associated with a first communication device;
receive a plurality of audio stream snippets from the communications system base station;
determine at least one audio stream snippet characteristic for each received audio stream snippet of the plurality of received audio stream snippets;
determine whether an audio stream snippet of the plurality of received audio stream snippets is relevant to the user associated with the first communication device based on the determined at least one audio stream snippet characteristic and the at least one user attribute; and
transmit via the communications system base station data corresponding to at least one audio stream snippet of the plurality of received audio stream snippets to the first communication device when the at least one audio stream snippet is determined to be relevant to the user associated with the first communication device.

11. The system of claim 10, wherein determining the at least one user attribute includes determining the at least one attribute from a group of attributes consisting of a field role, a current task, a current status, a communication status, a location, a skill, an equipment association, and a context value; and
determining the at least one audio stream snippet characteristic include determining the at least one audio stream snippet characteristic based on the at least one user attribute of the user associated with the first communication device.

12. The system of claim 10, wherein determining the at least one audio stream snippet characteristic includes determining at least one characteristic from a group of characteristics consisting of an audio stream relevance, an audio stream severity, a push-to-talk audio traffic volume, and an audio stream source reference.

13. The system of claim 10, wherein the electronic processor is further configured to determine at least one annotation based on the at least one audio stream snippet, and wherein transmitting the data corresponding to the at least one audio stream snippet includes transmitting the at least one annotation.

14. The system of claim 13, wherein determining the at least one annotation includes determining an audio stream snippet emergency level, an audio stream snippet source, snippet rich data, and snippet logical meta data.

15. The system of claim 10, wherein the processor is further configured to
determine at least one sending user attribute for a sending user associated with a second communication device, and
wherein determining whether an audio stream snippet of the plurality of received audio stream snippets is relevant to the user associated with the first communication device is based on the at least one sending user.

16. The system of claim 15, wherein determining the at least one sending user attribute includes determining at least one attribute from a group of attributes consisting of a field role, a current task, a current status, a communication status, a location, a skill, an equipment association, and a contest value.

17. The system of claim 10, wherein the electronic processor is further configured to
determine a late-joined role status for the user associated with the first communication device; and
wherein determining whether an audio stream snippet of the plurality of received audio stream snippets is relevant to the user associated with the first communication device is based on the late-joined role status.

18. The system of claim 10, wherein the electronic processor is further configured to
determine a priority threshold tor the user associated with the first communication device; and
determine a priority value for each received audio stream snippet of the plurality of received audio stream snippets based on the at least one audio stream snippet characteristic; and
wherein determining whether an audio stream snippet of the plurality of received audio stream snippets is relevant to the user associated with the first communication device is based on the priority threshold and the priority value.
